(19) United States
(12) Patent Application Publication
(10) Pub. No.: US 2008/0282053 A1
(43) Pub. Date: Nov. 13, 2008

(54) METHOD FOR CONVERTING MEMORY ADDRESSES OF DIFFERENT PROGRAMMABLE LOGIC CONTROLLERS CONNECTED TO HUMAN-MACHINE INTERFACE

(76) Inventors: Yong-Liang Chang, Taoyuan Shien (TW); Chin-Yih Yang, Taoyuan Shien (TW)

Correspondence Address: HDSL, 4331 STEVENS BATTLE LANE, FAIRFAX, VA, 22033, US

(21) Appl. No.: 11/746,157

(22) Filed: May 9, 2007

(51) Int. Cl. G06F 12/00

(52) U.S. Cl. 711/202

(57) ABSTRACT

A method converts the memory addresses of different programmable logic controllers (PLC) connected to human-machine interface (HMI). The PLCs of different specifications are associated with different memory addresses. The memory address data corresponding to PLCs with various specifications is first established in HMI. A mapping condition is checked for the memory type and memory size for the PLC with different specification. A mapping relationship is established when the mapping condition is satisfied and data is automatically sent to the memory area of the new PLC.

### BACKGROUND OF THE INVENTION

1. Field of the Invention

The present invention relates to programmable logic controller (PLC), and more particularly relates to the memory address setting of PLC.

2. Description of Prior Art

Programmable logic controllers (PLC) are extensively used in automatic control for industry. The PLC mainly comprises memory for storing program and I/O ports for connecting to the controlled device. The controlled device sends the status information thereof and the measurement signals thereof to the PLC and then the PLC sends corresponding control signals to the controlled device according to the status information and the measurement signals of the controlled device.

The conventional programming method for PLC is to directly write in control program manually to PLC one by one. A modern approach adopts human-machine interface (HMI) as console and uses Window application software to program one or more PLC. However, there is no unified specification for the PLC. The specifications for PLC are various according to different manufactures such as ABB, Koyo, Honeywell, Siemens, Modicon, Omron, Allen-Bradley, General Electric, Tesco Controls, Panasonic (Matsushita), Mitsubishi and Delta (the applicant of the subject application). The specifications, for example, include integer type and bit type. The memory size and address for memory area associated with the specifications are also different. After a PLC having specification Al and made by company A is installed and set up, the setting in the HMI cannot be re-used when the original PLC is replaced by a PLC having specification B1 and made by company B. The setting in the HMI should be updated. This is uneconomical for user and it is desirable to provide a convenient way for changing specification for PLC.

### SUMMARY OF THE INVENTION

It is the object of the present invention to provide a method for converting memory addresses of programmable logic controllers (PLCs) having different specifications and connected to a human-machine interface (HMI). After the PLC with new specification is selected, the memory address for the PLCs of different specifications can be directly converted without the requirement of re-setting.

Accordingly, the present invention provides a method for converting memory addresses of programmable logic controllers having different specifications. The memory address data corresponding to PLCs with various specifications is first established in HMI. A mapping condition is checked for the memory type and memory size for the PLCs with different specification. A mapping relationship is established when the mapping condition is satisfied and data is automatically sent to the memory area of the new PLC.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows the flowchart for the method of the present invention.

FIG. 2 shows the schematic drawings for demonstrating the mapping relationship in memory address of PLC with two different specifications.

### DETAILED DESCRIPTION OF THE INVENTION

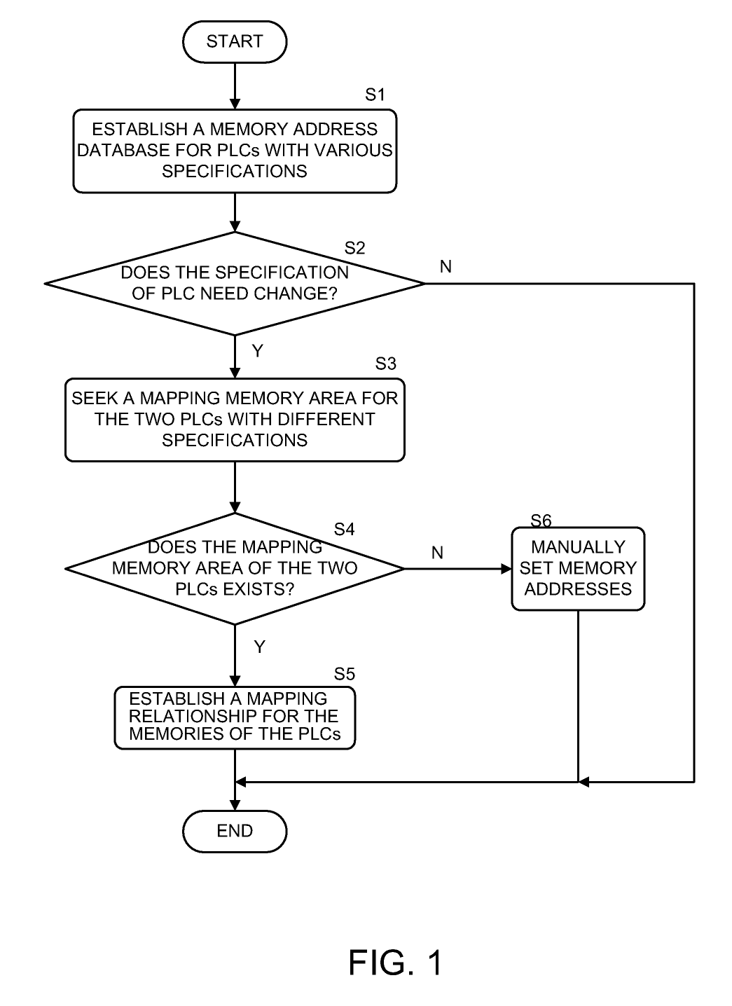

The present invention is applied for an HMI (not shown) connected to at least one PLC (not shown), where the HMI is used to program the PLC. FIG. 1 shows the flowchart for the method of the present invention. The memory address data for various PLC specifications is established in the HMI (step S1). After a user has set up a PLC with the first specification, Step S2 checks whether the first PLC specification needs to change into the second specification. If true, the HMI seeks the memory address areas corresponding to two PLC specifications in the memory address data (step S3). Step S4 checks whether a mapping condition is satisfied for the two PLC specifications, namely, whether memory size of the memory area associated with the PLC with the second specification is larger than or equal to that of the PLC with the first specification, and whether the memory areas associated with the two specifications are of the same type (integer type or bit type). If the mapping condition is satisfied for the two PLC specifications, a mapping relationship is established in step S5 for automatic address conversion, where the programming and setting for the PLC with the first specification is directly written into the PLC with the second specification. If the mapping condition is not satisfied for the two PLC specifications, (namely, the memory capacity of the memory area associated with the PLC with the second specification is smaller than that of the PLC with the first specification; or the two specifications are of the different types), a manual setting and programming is performed (step S6).

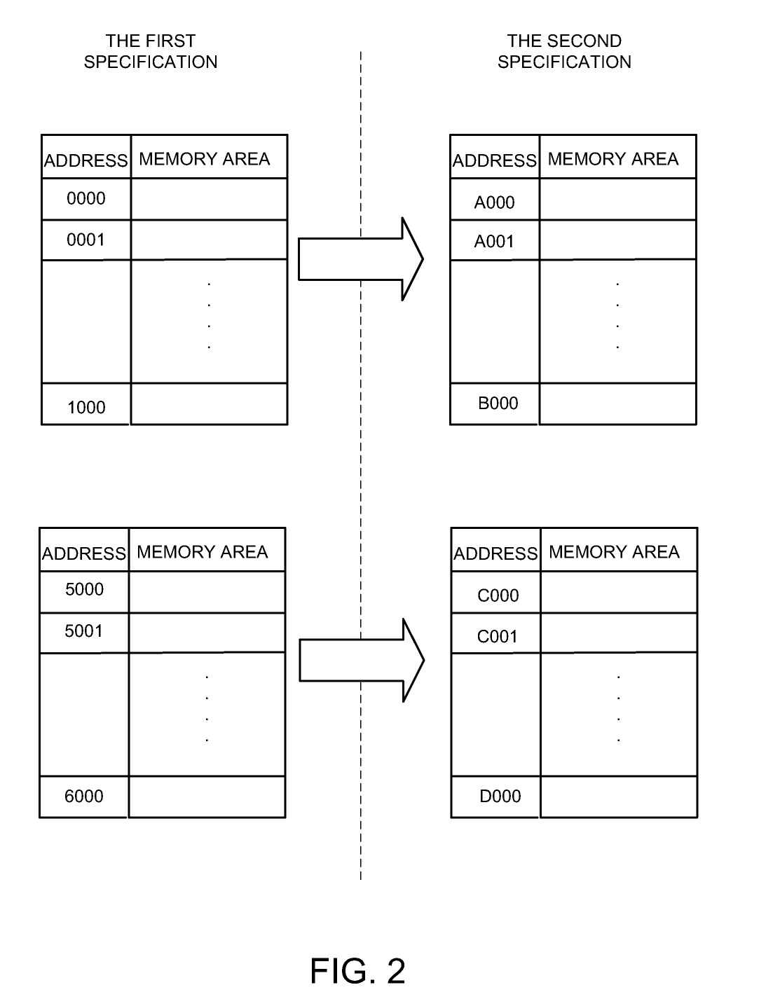

FIG. 2 shows the schematic drawings for demonstrating the mapping relationship in memory address of PLC with two different specifications. The memory area of the PLC with the first specification includes the memory addresses 0000-1000 and 5000-6000. The memory area of the PLC with the second specification has the same size as that of the PLC with the first specification. The memory area of the PLC with the second specification includes the memory addresses A000-B000 and C000-D000. In this situation, a mapping condition is satisfied for the two PLC specifications. The HMI establish a mapping relationship to map the address 0000 of the PLC with the first specification to the address A000 of the PLC with the second specification; to map address 0001 of the PLC with the first specification to the address A001 of the PLC with the second specification; to map the address 5000 of the PLC with the first specification to the address C000 of the PLC with the second specification etc. The data to be sent to the address 0000 of the PLC with the first specification can be automatically sent to the address A000 of the PLC with the second specification. This demonstrates the situation for step S4 of FIG. 1, namely, mapping condition is satisfied.

When the memory size of the memory associated with the PLC with the second specification is larger than that of the PLC with the first specification, memory areas for the PLC with the second specification can be randomly or sequentially selected as long as the selected memory areas have the same size as that of memory areas for the PLC with the first specification. The mapping condition can also be satisfied after the selection and mapping relationship can also be established. The original setting and programming can be directly written into memory of the PLC with the second specification. It provides great convenience for user.

Although the present invention has been described with reference to the preferred embodiment thereof, it will be understood that the invention is not limited to the details thereof Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A method for converting memory addresses of programmable logic controllers (PLCs) with different specifications and connected to a human-machine interface (HMI), the method converting a memory address of a PLC with a first specification to a memory address of another PLC with a second specification and comprising:
establishing a memory address database for PLCs with various specifications;
seeking a mapping memory area for the two PLCs with the first and second specifications, respectively, where the mapping memory area exists when a size of a memory of the PLC with the second specification is larger than or equal to that of the PLC with the first specification;
establishing a mapping relationship for the memories of the two PLCs when the mapping memory area exists.
